(19) United States
(12) Patent Application Publication
(10) Pub. No.: US 2023/0274365 A1
(43) Pub. Date: Aug. 31, 2023

(54) RECOMMENDATION DEVICE

(71) Applicant: NTT DOCOMO, INC., Chiyoda-ku (JP)

(72) Inventors: Takahito ISHII, Chiyoda-ku (JP); Tsukasa DEMIZU, Chiyoda-ku (JP); Yusuke FUKAZAWA, Chiyoda-ku (JP)

(73) Assignee: NTT DOCOMO, INC., Chiyoda-ku (JP)

(21) Appl. No.: 18/041,027

(22) PCT Filed: Aug. 11, 2021
(86) PCT No.: PCT/JP2021/029645

§ 371 Date: Feb. 8, 2023

(30) Foreign Application Priority Data
Aug. 27, 2020 (JP) 2020-143631

(51) Int. Cl. G06Q 40/08

(52) U.S. Cl. CPC G06Q 40/08

(57) ABSTRACT

A recommendation device includes: a determination unit that determines a combination of insurance products and insurance premiums to be paid to the insurance products from among a plurality of insurance products based on a risk degree indicating a degree of damage caused to a user due to an event to be compensated for by each of the plurality of insurance products and a compensation degree indicating a degree of compensation by each of the plurality of insurance products; and an output unit that outputs recommendation information indicating the combination and the insurance premiums.

### TECHNICAL FIELD

The present disclosure relates to a recommendation device.

### BACKGROUND ART

Techniques for providing a user with an appropriate combination of insurance products are known. For example, Patent Literature 1 describes an information processing device that acquires behavior information of a user, predicts a future risk of the user on the basis of the behavior information, determines a combination of insurance-related products necessary for the user on the basis of the risk, allocates insurance premiums to the insurance-related products according to the risk within a range of the insurance premium set by the user, and provides the combination of insurance-related products to the user.

### CITATION LIST

### Patent Literature

Patent Literature 1: Japanese Unexamined Patent Publication No. 2019-144775

### SUMMARY OF INVENTION

### Technical Problem

The amount of money (compensation amount) to be paid per unit varies depending on the insurance product. However, in the information processing device described in Patent Literature 1, since the insurance premium is allocated without considering the compensation amount, there is a possibility that the loss cannot be sufficiently compensated.

The present disclosure describes a recommendation device capable of optimizing a combination of insurance products and insurance premiums.

### Solution to Problem

A recommendation device according to an aspect of the present disclosure includes: a determination unit that determines a combination of insurance products and insurance premiums to be paid to the insurance products from among a plurality of insurance products based on a risk degree indicating a degree of damage caused to a user due to an event to be compensated for by each of the plurality of insurance products and a compensation degree indicating a degree of compensation by each of the plurality of insurance products; and an output unit that outputs recommendation information indicating the combination and the insurance premiums.

In the recommendation device, a combination of insurance products and insurance premiums to be paid to the insurance products are determined from among a plurality of insurance products based on a risk degree and a compensation degree of each of the plurality of insurance products, and recommendation information is output. Since not only the risk degree but also the compensation degree is considered, for example, the combination of the insurance products and the insurance premiums can be determined so as to be compensated for various risks of the user in a balanced manner. As a result, it is possible to optimize the combination of insurance products and the insurance premiums.

### Advantageous Effects of Invention

According to the present disclosure, it is possible to optimize a combination of insurance products and insurance premiums.

### BRIEF DESCRIPTION OF DRAWINGS

FIG. 1 is a schematic configuration diagram of a recommendation system including a recommendation device according to an embodiment.

FIG. 2(a) is a diagram showing an example of user basic information stored in the user information database (DB) shown in FIG. 1. FIG. 2(b) is a diagram showing an example of position information stored in the user information DB shown in FIG. 1. FIG. 2(c) is a diagram showing an example of settlement information stored in the user information DB shown in FIG. 1.

FIG. 3 is a diagram showing an example of insurance subscription information stored in the insurance subscription information DB shown in FIG. 1.

FIG. 4 is a block diagram showing a functional configuration of the recommendation device shown in FIG. 1.

FIG. 5 is a sequence diagram showing a series of processes of a recommendation method performed by the recommendation system shown in FIG. 1.

FIG. 6 is a flowchart showing in detail the determination process shown in FIG. 5.

FIG. 7 is a diagram showing an example of a display screen of recommendation information.

FIG. 8 is a diagram for explaining a degree of overlap between two insurance products.

FIG. 9 is a diagram for explaining a compensation score.

FIG. 10 is a diagram showing a hardware configuration of the recommendation device shown in FIG. 1.

### DESCRIPTION OF EMBODIMENTS

In the following, embodiments of the present disclosure will be described with reference to the drawings. It should be noted that in the description of the drawings, the same components are designated with the same reference signs, and the redundant description is omitted.

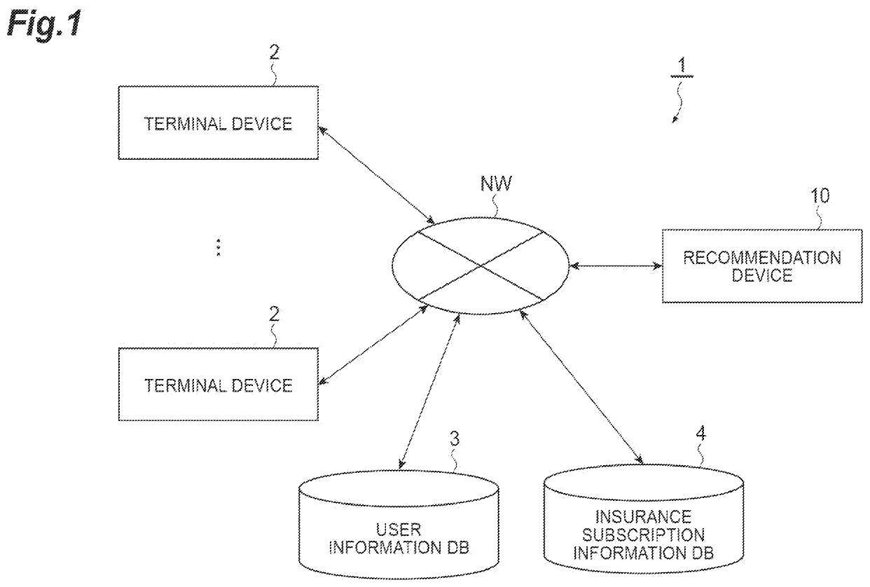

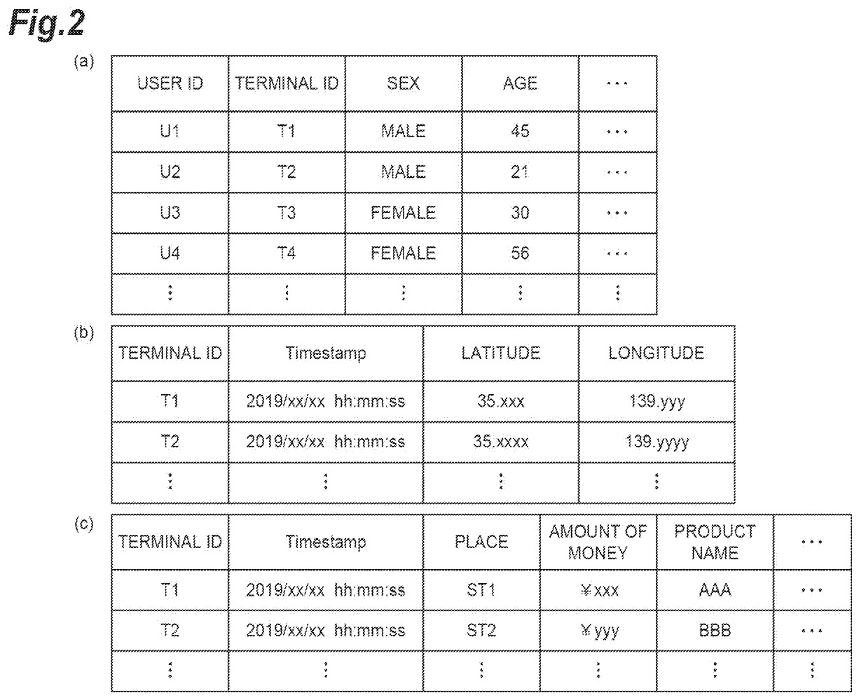

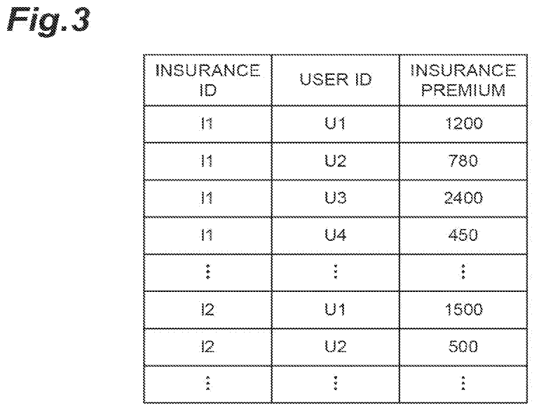

A configuration of a recommendation system including a recommendation device according to an embodiment will be described with reference to FIGS. 1 to 3. FIG. 1 is a schematic configuration diagram of a recommendation system including a recommendation device according to an embodiment. FIG. 2(a) is a diagram showing an example of user basic information stored in the user information database (DB) shown in FIG. 1. FIG. 2(b) is a diagram showing an example of position information stored in the user information DB shown in FIG. 1. FIG. 2(c) is a diagram showing an example of settlement information stored in the user information DB shown in FIG. 1. FIG. 3 is a diagram showing an example of insurance subscription information stored in the insurance subscription information DB shown in FIG. 1.

A recommendation system 1 shown in FIG. 1 is a system for recommending a combination of insurance products and insurance premiums (portfolio) to a user.

The recommendation system 1 includes a plurality of terminal devices 2, a user information DB 3, an insurance subscription information DB 4, and a recommendation device 10. The plurality of terminal devices 2, the user information DB 3, the insurance subscription information DB 4, and the recommendation device 10 are configured to be able to communicate with each other via a network NW. The network NW may be configured in a wired or wireless manner. Examples of the network NW include a mobile communication network, the Internet, and a wide area network (WAN). In the following description, a description will be given mainly focusing on one terminal device 2, but the same applies to other terminal devices 2.

The terminal device 2 is a device used by a user. Examples of the terminal device 2 include a smartphone, a tablet terminal, a laptop, and a desktop personal computer (PC).

The terminal device 2 acquires position information (latitude and longitude) of the terminal device 2 using a global positioning system (GPS) or the like. The terminal device 2 may acquire information on a position where a master station of a wireless network to which the terminal device 2 is connected is installed as the position information. Examples of the position where the master station is installed include a base station of a mobile network and an access point of Wi-Fi. The terminal device 2 may acquire position information of a terminal present in the vicinity of the terminal device 2 as the position information of the terminal device 2. Examples of such a terminal include a beacon terminal of Bluetooth (registered trademark). Details of the position information will be described later. The terminal device 2 periodically transmits the position information to the user information DB 3.

The terminal device 2 generates settlement information related to settlement performed by the user using the terminal device 2. For example, when the user purchases a product using a settlement application installed in the terminal device 2, the terminal device 2 generates settlement information. Details of the settlement information will be described later. The terminal device 2 transmits the settlement information to the user information DB 3, for example, every time the settlement information is generated.

The user information DB 3 is a database that stores user information of each user. The user information is information about a user, and includes user basic information, position information, and settlement information. The user information may further include other information such as a use history (log) of the terminal device 2. The user basic information is basic information of the user. As shown in FIG. 2(a), the user basic information includes a user identifier (ID), a terminal ID, sex, and age. The user ID is information capable of uniquely identifying a user. The terminal ID is information capable of uniquely identifying the terminal device 2. Here, the terminal ID indicates the terminal device 2 used by the user identified by the user ID. The user basic information may further include other information. The user basic information is set in advance by the user, for example.

The position information is information indicating the position of each terminal device. As shown in FIG. 2(b), the position information includes a terminal ID, a time (time stamp) at which the position information is acquired, a latitude, and a longitude. When receiving the position information from each terminal device 2, the user information DB 3 stores the received position information. In the user information DB 3, a plurality of pieces of position information of each terminal device 2 are stored as a history (log) of the position information.

The settlement information is information related to settlement performed using each terminal device 2. As shown in FIG. 2(c), the settlement information includes a terminal ID, a time when the settlement is performed, a place where the settlement is performed, an amount of money, and a product name. When receiving the settlement information from each terminal device 2, the user information DB 3 stores the received settlement information. In the user information DB 3, a plurality of pieces of settlement information of each terminal device 2 are stored as a history of the settlement information.

The insurance subscription information DB 4 is a database that stores insurance subscription information of each user. The insurance subscription information is information related to an insurance product to which each user subscribes. As shown in FIG. 3, the insurance subscription information includes an insurance ID, a user ID, and an insurance premium. The insurance ID is information capable of uniquely identifying an insurance product. The insurance premium is the amount of money that the user identified by the user ID pays for the insurance product identified by the insurance ID. The insurance premium is, for example, an insurance premium per month. The insurance subscription information may include the number of purchased units in place of the insurance premium, or may include the number of purchased units together with the insurance premium.

The recommendation device 10 is a device that recommends an optimal combination of insurance products and optimal insurance premiums to a user from among a plurality of insurance products. An example of the recommendation device 10 is an information processing device such as a server device.

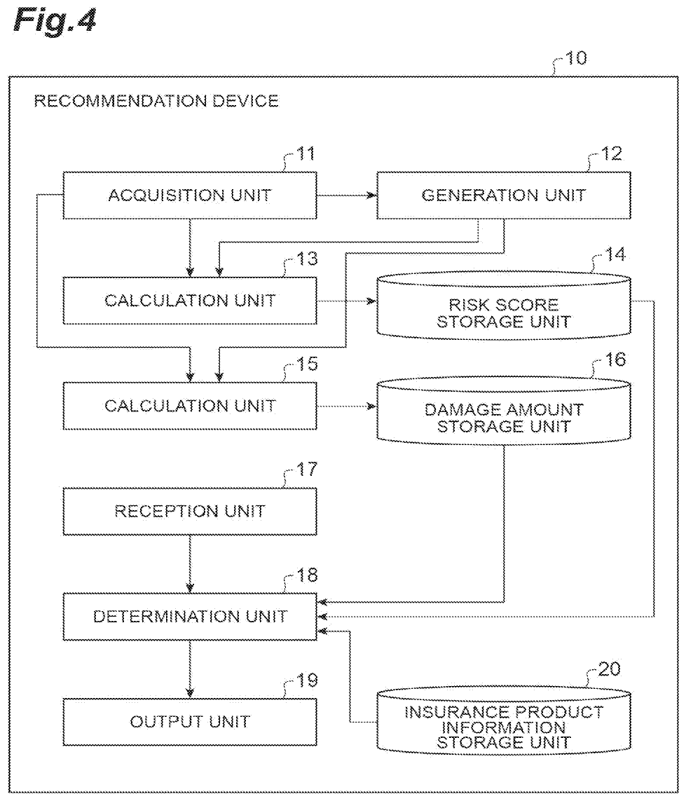

A functional configuration of the recommendation device 10 will be described with reference to FIG. 4. FIG. 4 is a block diagram showing a functional configuration of the recommendation device shown in FIG. 1. As shown in FIG. 4, the recommendation device 10 functionally includes an acquisition unit 11, a generation unit 12, a calculation unit 13, a risk score storage unit 14, a calculation unit 15, a damage amount storage unit 16, a reception unit 17, a determination unit 18, an output unit 19, and an insurance product information storage unit 20.

The acquisition unit 11 is a functional unit that acquires user information and insurance subscription information. The acquisition unit 11 acquires user information from the user information DB 3 and acquires insurance subscription information from the insurance subscription information DB 4.

The generation unit 12 is a functional unit that generates a subscription prediction model and an insurance premium prediction model. The subscription prediction model is a machine learning model in which a feature generated from user information is used as an explanatory variable and a subscription score of an insurance product is used as an objective variable, and is configured by, for example, a neural network. The subscription score is a value indicating a possibility that the user subscribes to the insurance product. The subscription score is a numerical value within a range of 0 to 1, for example. For example, the larger the subscription score of an insurance product, the more likely the user will subscribe to the insurance product. The generation unit 12 generates a subscription prediction model of each insurance product by performing machine learning for each insurance product.

The insurance premium prediction model is a machine learning model in which a feature generated from user information is used as an explanatory variable and a predicted insurance premium is used as an objective variable, and is configured by, for example, a neural network. The predicted insurance premium is an insurance premium that the user is predicted to pay for the insurance product, and is obtained by, for example, multiplying the insurance premium per unit by the number of purchased units. The generation unit 12 generates an insurance premium prediction model of each insurance product by performing machine learning for each insurance product. A method of generating a feature, a method of generating a subscription prediction model, and a method of generating an insurance premium prediction model will be described later.

The calculation unit 13 is a functional unit that calculates a risk score for each of the plurality of insurance products based on the user information. The risk score is a value indicating a possibility (occurrence probability) that an event to be compensated for by the insurance product occurs in the user. The subscription score is considered to have a correlation with the risk score. Therefore, the calculation unit 13 calculates the risk score based on the subscription score. The calculation unit 13 calculates a subscription score using the subscription prediction model. The calculation unit 13 generates a feature from the user information and inputs the generated feature to the subscription prediction model to obtain a subscription score from the subscription prediction model. For example, the calculation unit 13 may use the subscription score as the risk score, or may calculate the risk score by multiplying the subscription score by a predetermined coefficient.

The risk score storage unit 14 is a functional unit that stores the risk score for each insurance product of each user. The risk score storage unit 14 stores, for example, a data set in which a user ID, an insurance ID, and a risk score are associated with one another.

The calculation unit 15 is a functional unit that calculates a predicted average damage amount for each of the plurality of insurance products based on the user information. The predicted average damage amount is an average amount of money that is predicted to be lost by an event to be compensated for by the insurance product. Since the predicted insurance premium is predicted as an amount of money that can compensate for an amount of damage caused by an event to be compensated for by the insurance product, the predicted insurance premium is considered to have a correlation with the predicted average damage amount. Therefore, the calculation unit 15 calculates the predicted average damage amount based on the predicted insurance premium. The calculation unit 15 calculates the predicted insurance premium using the insurance premium prediction model. The calculation unit 15 generates a feature from the user information and inputs the generated feature to the insurance premium prediction model to obtain a predicted insurance premium from the insurance premium prediction model. The calculation unit 15 calculates the predicted average damage amount by multiplying the predicted insurance premium by a predetermined coefficient, for example.

The damage amount storage unit 16 is a functional unit that stores the predicted average damage amount for each insurance product of each user. The damage amount storage unit 16 stores, for example, a data set in which a user ID, an insurance ID, and a predicted average damage amount are associated with one another.

The reception unit 17 is a functional unit that receives a recommendation request from the terminal device 2. The recommendation request is a command for requesting recommendation information of an insurance product. The recommendation request includes the user ID of the user who requests the recommendation information and the payable amount Cost^{max}. The payable amount Cost^{max} is set by the user and is an upper limit amount of money which the user can pay for insurance products. The payable amount Cost^{max} is, for example, an upper limit amount of money that the user can pay for insurance products per month.

The determination unit 18 is a functional unit that determines a portfolio of insurance products to be recommended to the user. The portfolio of insurance products includes a combination of insurance products and insurance premiums paid for each insurance product. Specifically, the determination unit 18 determines a combination of insurance products to be recommended to the user and an insurance premium to be paid to each insurance product from among a plurality of (n) insurance products based on the risk degree and the compensation degree of each of the plurality of insurance products. The risk degree is a value indicating the degree of damage caused to the user by an event to be compensated for by the insurance product. For example, a larger risk degree indicates a larger degree of damage. The compensation degree is a value indicating the degree of compensation by the insurance product. For example, a larger degree of compensation indicates a larger degree of compensation.

The determination unit 18 determines the portfolio of the insurance products so that the sum of the remaining risk degrees for the plurality of insurance products is minimized. The remaining risk degree is obtained by subtracting the compensation degree from the risk degree, for example. The determination unit 18 determines a portfolio of insurance products within the range of the payable amount Cost^{max} set by the user. The details of the method of determining the portfolio of insurance products will be described later.

The output unit 19 is a functional unit that outputs recommendation information indicating a portfolio of insurance products (combination of insurance products and insurance premiums). The output unit 19 outputs (transmits), for example, recommendation information to the terminal device 2. The output unit 19 may output the recommendation information to a memory (not shown) in the recommendation device 10.

The insurance product information storage unit 20 is a functional unit that stores insurance product information related to each insurance product. The insurance product information of each insurance product includes, for example, an insurance premium Cost per unit, a compensation amount Cᵢ per unit, and a lower limit value LBᵢ and an upper limit value UBᵢ of the number of purchased units. The number i of the insurance product is an integer value equal to or larger than 1 and equal to or less than the total number n of insurance products that can be recommended.

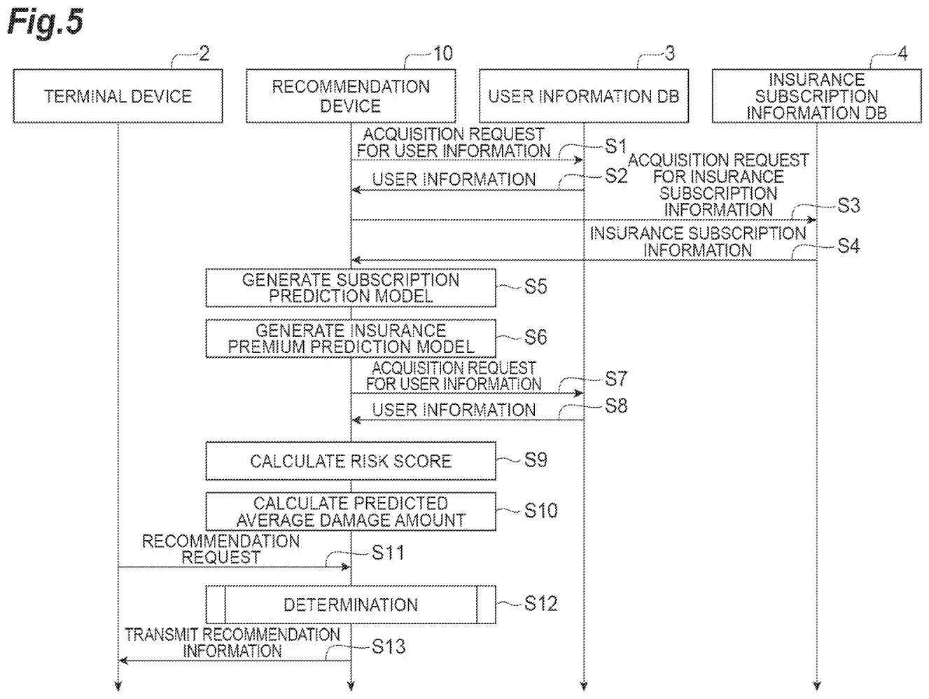

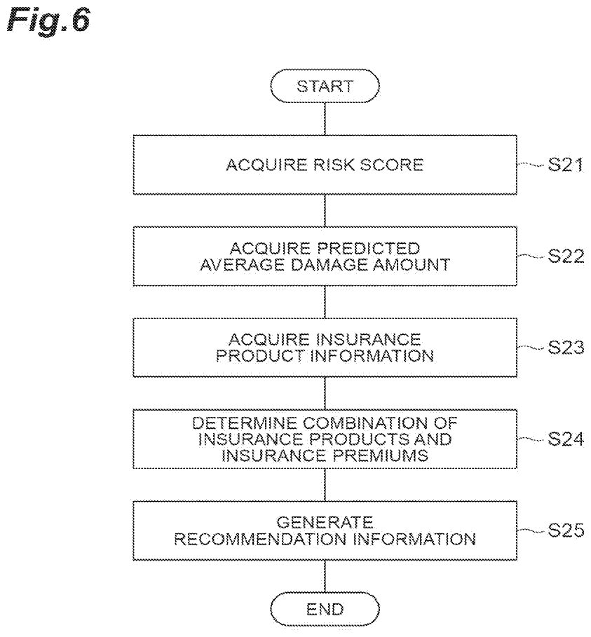

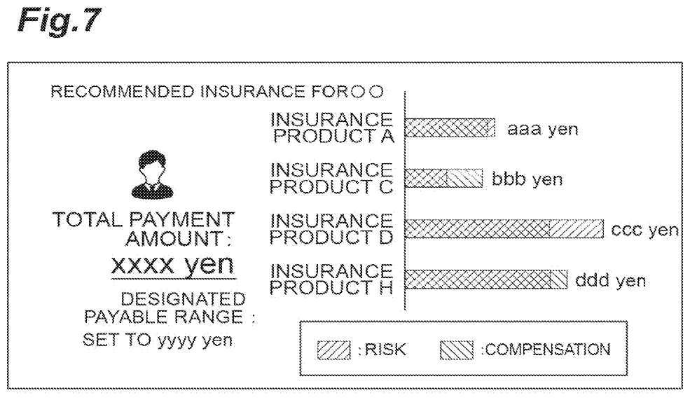

Next, a recommendation method performed by the recommendation system 1 (recommendation device 10) will be described with reference to FIGS. 5 to 7. FIG. 5 is a sequence diagram showing a series of processes of a recommendation method performed by the recommendation system shown in FIG. 1. FIG. 6 is a flowchart showing in detail the determination process shown in FIG. 5. FIG. 7 is a diagram showing an example of a display screen of recommendation information.

As shown in FIG. 5, first, the acquisition unit 11 of the recommendation device 10 transmits an acquisition request for the user information to the user information DB 3 (step S1). In step S1, the acquisition unit 11 may transmit an acquisition request for acquiring the user information of all users or may transmit an acquisition request for acquiring the user information of some users. Then, upon receiving the acquisition request for the user information from the recommendation device 10, the user information DB 3 transmits the requested user information to the recommendation device 10 (step S2).

Subsequently, the acquisition unit 11 of the recommendation device 10 transmits an acquisition request for the insurance subscription information to the insurance subscription information DB 4 (step S3). In step S3, the acquisition unit 11 transmits, for example, an acquisition request for acquiring insurance subscription information for all the insurance products that can be recommended. Then, upon receiving the acquisition request for the insurance subscription information from the recommendation device 10, the insurance subscription information DB 4 transmits the requested insurance subscription information to the recommendation device 10 (step S4).

When receiving the user information from the user information DB 3 and the insurance subscription information from the insurance subscription information DB 4, the acquisition unit 11 of the recommendation device 10 outputs the user information and the insurance subscription information to the generation unit 12. Subsequently, upon receiving the user information and the insurance subscription information from the acquisition unit 11, the generation unit 12 generates a subscription prediction model (step S5). In step S5, the generation unit 12 generates a subscription prediction model of each insurance product by performing machine learning for each insurance product. The machine learning is performed using, for example, a gradient boosting decision tree (GBDT) algorithm. In the machine learning, for example, a set of a feature generated from user information of a user who has subscribed to an insurance product in the past and a subscription score (=1) of the insurance product is used as correct data, and a set of a feature generated from user information of a user who has not subscribed to the insurance product and a subscription score (=0) of the insurance product is used as incorrect data. Then, the generation unit 12 outputs the subscription prediction model to the calculation unit 13.

Here, an example of a method for generating a feature will be described. The generation unit 12 uses the gender and age of the user information as features. The generation unit 12 may estimate a place where the user has stayed and a stay time from the time-series position information of the terminal device 2, and may use the stay place and the stay time as features. Further, in order to reduce the influence of the place where the user does not normally visit but happens to stay on the subscription score, the temporal change of the stay place and the stay time may be used as features. The generation unit 12 calculates the number of times of settlement, the number of stores in which settlement has been performed, and the total of the settlement amount as features from the settlement information of the terminal device 2. The amount of money for each genre of the settled product (service) may be used as a feature.

Further, the generation unit 12 generates an insurance premium prediction model (step S6). In step S6, the generation unit 12 generates an insurance premium prediction model of each insurance product by performing machine learning for each insurance product. The machine learning is performed using, for example, a GBDT algorithm. In the machine learning, for example, a set of a feature generated from user information of a user who has subscribed to an insurance product in the past and an insurance premium paid to the insurance product by the user is used as correct data. The method of generating the feature is as described above. Then, the generation unit 12 outputs the insurance premium prediction model to the calculation unit 15.

Subsequently, the acquisition unit 11 transmits an acquisition request for acquiring the user information of all users to the user information DB 3 (step S7). Then, upon receiving the acquisition request for the user information from the recommendation device 10, the user information DB 3 transmits the requested user information to the recommendation device 10 (step S8). Upon receiving the user information from the user information DB 3, the acquisition unit 11 outputs the user information to the calculation unit 13 and the calculation unit 15.

Subsequently, upon receiving the user information from the acquisition unit 11, the calculation unit 13 calculates a risk score of each user for each of the plurality of insurance products (step S9). In step S9, the calculation unit 13 first calculates a subscription score using the subscription prediction model. Specifically, the calculation unit 13 generates the feature from the user information of each user in the same manner as the generation method of the feature by the generation unit 12. Then, the calculation unit 13 inputs the feature to the subscription prediction model of each insurance product for each user, and obtains the subscription score output from each subscription prediction model. Then, the calculation unit 13 calculates the risk score by multiplying the subscription score by a predetermined coefficient, for example. Then, the calculation unit 13 outputs a data set in which the user ID, the insurance ID, and the risk score are associated with each other to the risk score storage unit 14 and causes the risk score storage unit 14 to store the data set.

Subsequently, upon receiving the user information from the acquisition unit 11, the calculation unit 15 calculates the predicted average damage amount of each user for each of the plurality of insurance products (step S10). In step S10, the calculation unit 15 first calculates a predicted insurance premium using the insurance premium prediction model. Specifically, the calculation unit 15 generates the feature from the user information of each user in the same manner as the generation method of the feature by the generation unit 12. Then, the calculation unit 15 inputs the feature to the insurance premium prediction model of each insurance product for each user, and obtains the predicted insurance premium output from each insurance premium prediction model. Then, the calculation unit 15 calculates the predicted average damage amount by multiplying the predicted insurance premium by a predetermined coefficient. Then, the calculation unit 15 outputs a data set in which the user ID, the insurance ID, and the predicted average damage amount are associated with one another to the damage amount storage unit 16 and causes the damage amount storage unit 16 to store the data set.

Subsequently, the terminal device 2 transmits a recommendation request to the recommendation device 10 (step S11). When receiving the recommendation request transmitted from the terminal device 2, the reception unit 17 of the recommendation device 10 outputs the user ID and the payable amount Cost^{max} included in the recommendation request to the determination unit 18.

Subsequently, upon receiving the user ID and the payable amount Cost^{max} from the reception unit 17, the determination unit 18 performs a determination process (step S12). As shown in FIG. 6, in the determination process of step S12, the determination unit 18 first acquires a risk score rᵢ for each insurance product of the user identified by the user ID (step S21). Specifically, the determination unit 18 acquires, from the risk score storage unit 14, sets of the insurance ID and the risk score rᵢ associated with the user ID received from the reception unit 17.

Then, the determination unit 18 acquires the predicted average damage amount Lossᵢ of the user identified by the user ID for each insurance product (step S22). Specifically, the determination unit 18 acquires, from the damage amount storage unit 16, sets of the insurance ID and the predicted average damage amount Lossᵢ associated with the user ID received from the reception unit 17. Then, the determination unit 18 acquires the insurance product information on the n insurance products that can be recommended to the user (step S23). Specifically, the determination unit 18 acquires the insurance product information on the n insurance products from the insurance product information storage unit 20.

Subsequently, the determination unit 18 determines a portfolio of insurance products to be recommended to the user (step S24). In step S24, the determination unit 18 uses the sets of the insurance product ID and the risk scores rᵢ acquired from the risk score storage unit 14, the sets of the insurance product ID and the predicted average damage amounts Lossᵢ acquired from the damage amount storage unit 16, and the insurance product information acquired from the insurance product information storage unit 20 to determine a combination of insurance products to be recommended to the user and insurance premiums to be paid to each insurance product from among the n insurance products based on the risk degrees and compensation degrees for the n insurance products. In the present embodiment, the risk degree is a predicted damage amount caused by an event that is a compensation target of an insurance product, and the compensation degree is a compensation amount paid depending on an insurance premium of the insurance product.

Specifically, the determination unit 18 determines the combination of the insurance products and the insurance premiums such that the sum of the remaining damage amounts obtained by subtracting the compensation amounts from the predicted damage amounts for the n insurance products is minimized as shown in Equation (1). The predicted damage amount is obtained by multiplying the risk score rᵢ by the predicted average damage amount Lossᵢ. The compensation amount is obtained by multiplying the compensation amount Cᵢ per unit by the number of purchased units xᵢ. The number of purchased units xᵢ is an integer value of 0 or more. When the compensation amount (=Cᵢ×xᵢ) is larger than the predicted damage amount (=rᵢ×Lossᵢ), it means overcompensation. In this case, the remaining damage amount is regarded as 0.

$$\begin{matrix}[ Equation 1 ] & \\ min {\sum }_{i = 1}^{n} max \{ {r}_{i} \times {Loss}_{i} - {C}_{i} \times {x}_{i} , 0 \} & ( 1 )\end{matrix}$$

Furthermore, the determination unit 18 minimizes Equation (1) so as to satisfy the constraint conditions represented by Equations (2) to (4).

$$\begin{matrix}[ Equation 2 ] & \\ {\sum }_{i = 1}^{n} {u}_{i} \leq K & ( 2 )\end{matrix}$$

$$\begin{matrix}[ Equation 3 ] & \\ {\sum }_{i = 1}^{n} {Cost}_{i} \times {x}_{i} \leq {Cost}^{max} & ( 3 )\end{matrix}$$

$$\begin{matrix}[ Equation 4 ] & \\ {LB}_{i} \times {u}_{i} \leq {x}_{i} \leq {UB}_{i} \times {u}_{i} & ( 4 )\end{matrix}$$

Equation (2) defines the upper limit number of insurance products that can be included in the portfolio, and represents a constraint condition that the sum of the selection flags uᵢ of the first to n-th insurance products is equal to or less than the upper limit number K. The selection flag uᵢ indicates whether the i-th insurance product is selected as an insurance product to be included in the portfolio. When the i-th insurance product is selected as an insurance product to be included in the portfolio, the selection flag uᵢ is set to 1. When the i-th insurance product is not selected as an insurance product to be included in the portfolio, the selection flag uᵢ is set to 0. Therefore, the determination unit 18 determines the number of insurance products so as to be within the upper limit number K.

Equation (3) defines an upper limit of the total amount of insurance premiums, and represents a constraint condition that the sum of the insurance premiums of the first to n-th insurance products is equal to or less than the payable amount Cost^{max}. The insurance premium of each insurance product is obtained by multiplying the insurance premium Costᵢ per unit by the number of purchased units xᵢ. Therefore, the determination unit 18 determines the portfolio of insurance products within the range of the payable amount Cost^{max} set by the user.

Equation (4) defines a lower limit and an upper limit of the number of purchased units of each insurance product, and represents a constraint condition that the number of purchased units xᵢ of each insurance product is within a range from the lower limit value LBᵢ to the upper limit value UBᵢ. It should be noted that since the number of purchased units xᵢ is 0 for an insurance product for which no one unit is purchased, the number of purchased units xᵢ may not fall within the range from the lower limit value LBᵢ to the upper limit value UBᵢ. Therefore, the determination unit 18 determines the number of purchased units xᵢ within a range from the multiplication result obtained by multiplying the lower limit value LBᵢ by the selection flag uᵢ to the multiplication result obtained by multiplying the upper limit value UBᵢ by the selection flag uᵢ.

Subsequently, the determination unit 18 generates recommendation information indicating the portfolio of the insurance products (step S25). For example, the determination unit 18 generates recommendation information including names and insurance premiums of the insurance products included in the portfolio. The recommendation information may further include the payable amount Cost^{max} and a total amount of the insurance premiums (total payment amount). The recommendation information may further include a predicted damage amount and a compensation amount of each insurance product. Then, the determination unit 18 outputs the recommendation information to the output unit 19.

Subsequently, the output unit 19 transmits the recommendation information to the terminal device 2 (step S13). When receiving the recommendation information transmitted from the recommendation device 10, the terminal device 2 displays the recommendation information on the display. For example, as shown in FIG. 7, the names and insurance premiums of the insurance products included in the portfolio are displayed together with a graph indicating the risk (predicted damage amount) and compensation (compensation amount) of each insurance product. Further, the total amount of the insurance premiums (total payment amount) is displayed together with the payable amount Cost^{max} set by the user.

According to the display screen example of FIG. 7, how much the recommended insurance products compensate for the potential risk of the user is visually displayed. Therefore, it is possible to increase the user's sense of satisfaction. Since the user can recognize the missing compensation, it becomes clear what insurance product should be subscribed to when the user customizes the insurance products.

As described above, a series of processes of the recommendation method ends. Steps S1 to S10 are performed in advance before a recommendation request is received from the terminal device 2 (offline processing). Step S3 and step S4 may be performed before step S1 and step S2, or may be performed in parallel with step S1 and step S2. Step S6 may be performed before step S5, or may be performed in parallel with step S5. Step S10 may be performed before step S9, or may be performed in parallel with step S9. Steps S21 to S23 may be performed in any order, or may be performed in parallel with each other.

After step S11, steps S7 to S10 may be performed. In this case, in step S7, the acquisition unit 11 transmits an acquisition request for acquiring the user information of the user identified by the user ID included in the recommendation request to the user information DB 3, and in step S8, the user information DB 3 transmits the requested user information of the user to the recommendation device 10. Further, in step S9, the calculation unit 13 calculates the risk score of the user identified by the user ID included in the recommendation request, and outputs the risk score to the determination unit 18. In step S10, the calculation unit 15 calculates the predicted average damage amount of the user identified by the user ID included in the recommendation request, and outputs the predicted average damage amount to the determination unit 18.

In the recommendation device 10 described above, the combination of the insurance products and the insurance premiums to be paid to the insurance products are determined from among the n insurance products based on the predicted damage amount and the compensation amount of each of the n insurance products, and the recommendation information is output. Since not only the predicted damage amount but also the compensation amount is considered, for example, the combination of the insurance products and the insurance premiums can be determined so as to be compensated in a balanced manner with respect to various risks of the user. As a result, it is possible to optimize the combination of insurance products and the insurance premiums.

Specifically, the determination unit 18 determines the combination of the insurance products and the insurance premiums so that the sum of the remaining damage amounts obtained by subtracting the compensation amounts from the predicted damage amounts for the n insurance products is minimized. Since it can be said that the less the sum of the remaining damage amounts is, the more sufficient the preparation for all risks is, it can be said that the combination of the insurance products and the insurance premiums in which the sum of the remaining damage amounts is minimized are optimal for the user. Therefore, according to the above configuration, it is possible to optimize the combination of the insurance products and the insurance premiums.

The determination unit 18 calculates a predicted damage amount based on a risk score indicating an occurrence probability of an event that is a compensation target of the insurance product. According to the Cortney theory, the risk is obtained by multiplying the occurrence probability of the risk by the degree of influence. The degree of influence can be regarded as an average amount of damage. Accordingly, the predicted damage amount may be determined by multiplying the risk score rᵢ by the predicted average damage amount Lossᵢ.

For example, after the combination of the insurance products and the insurance premiums are presented to the user without considering the total payment amount, the user may adjust the insurance premium to be equal to or less than the payable amount Cost^{max}. However, since the compensation content of the insurance product varies depending on the insurance premium, there is a possibility that optimum compensation cannot be obtained. In the recommendation device 10, the determination unit 18 determines a combination of insurance products and insurance premiums within a range of the payable amount Cost^{max} set by the user. According to this configuration, the combination of insurance products and the insurance premiums are determined in consideration of the upper limit of the total payment amount, and recommended to the user. Therefore, it is possible to further optimize the combination of insurance products and the insurance premiums. Since the total payment amount is equal to or less than the payable amount Cost^{max}, it is possible to increase the possibility that the user accepts the recommended content.

The calculation unit 13 calculates a subscription score indicating a possibility that the user subscribes to the insurance product for each of the n insurance products based on the user information, and calculates a risk score for each of the n insurance products based on the subscription score. It is considered that users having a common gender, age, behavior, and the like are equally likely to subscribe to insurance products. In addition, it is considered that the higher the possibility that the user subscribes to the insurance product, the higher the possibility that an event to be compensated for by the insurance product occurs in the user. In other words, there is a correlation between the subscription score and the risk score. Thus, the risk score may be obtained based on the subscription score. As described above, by using the user information, the risk score of each insurance product can be accurately calculated.

In order to directly calculate the risk score from the user information, it is necessary to use the user information of the user in which the event to be compensated for by the insurance product has actually occurred. However, since the event does not always occur frequently, a sufficient number of pieces of user information may not be obtained, and the calculation accuracy of the risk score may decrease. On the other hand, since it is considered that much more users than the number of users in which the event has occurred subscribe to the insurance product, the accuracy of calculating the subscription score from the user information is higher than the accuracy of calculating the risk score from the user information. Therefore, it is possible to improve the calculation accuracy of the risk score by using the subscription score.

Although embodiments of the present disclosure have been described above, the present disclosure is not limited to the above-described embodiments.

The recommendation device 10 may be configured by a single device coupled physically or logically, or may be configured by two or more devices that are physically or logically separated from each other. For example, the recommendation device 10 may be implemented by a plurality of computers distributed over a network such as cloud computing. As described above, the configuration of the recommendation device 10 may include any configuration that can realize the functions of the recommendation device 10.

The generation unit 12 may generate a risk prediction model instead of the subscription prediction model. The risk prediction model is a machine learning model in which a feature generated from user information is used as an explanatory variable and a risk score of an insurance product is used as an objective variable, and is configured by, for example, a neural network. The generation unit 12 may generate an average damage amount prediction model instead of the insurance premium prediction model. The average damage amount prediction model is a machine learning model in which a feature generated from user information is used as an explanatory variable and a predicted average damage amount occurring in a user due to an event to be compensated for by an insurance product is used as an objective variable, and is configured by, for example, a neural network.

The recommendation device 10 does not have to include the calculation unit 13 and the risk score storage unit 14. In this case, the determination unit 18 may acquire, from an external risk score storage unit, sets of the insurance ID and the risk score associated with the user ID included in the recommendation request. The recommendation device 10 does not have to include the calculation unit 15 and the damage amount storage unit 16. In this case, the determination unit 18 may acquire, from an external damage amount storage unit, sets of the insurance ID and the predicted average damage amount associated with the user ID included in the recommendation request. The recommendation device 10 does not have to include the insurance product information storage unit 20. In this case, the determination unit 18 may acquire the insurance product information from an external insurance product information storage unit.

The recommendation device 10 does not have to include the generation unit 12. In this case, the calculation unit 13 calculates the subscription score using a subscription prediction model generated in advance, and calculates the risk score based on the subscription score. The calculation unit 13 may calculate the subscription score on a rule basis or the like based on the user information without using the subscription prediction model, and calculate the risk score based on the subscription score. The calculation unit 13 may calculate the risk score using a risk prediction model generated in advance. The calculation unit 13 may calculate the risk score on a rule basis or the like based on the user information.

Similarly, the calculation unit 15 calculates the predicted insurance premium using an insurance premium prediction model generated in advance and calculates the predicted average damage amount based on the predicted insurance premium. The calculation unit 15 may calculate the predicted insurance premium on a rule basis or the like based on the user information without using the insurance premium prediction model, and calculate the predicted average damage amount based on the predicted insurance premium. The calculation unit 15 may calculate the predicted average damage amount using an average damage amount prediction model generated in advance. The calculation unit 15 may calculate the predicted average damage amount on a rule basis or the like based on the user information.

The recommendation device 10 does not have to include the acquisition unit 11, the generation unit 12, the calculation unit 13, the risk score storage unit 14, the calculation unit 15, the damage amount storage unit 16, and the insurance product information storage unit 20. In this case, the determination unit 18 may acquire, from an external risk score storage unit, the sets of the insurance ID and the risk score associated with the user ID included in the recommendation request, acquire, from an external damage amount storage unit, the sets of the insurance ID and the predicted average damage amount associated with the user ID, and acquire the insurance product information from an external insurance product information storage unit.

The compensation target of an insurance product varies depending on the insurance product, but the compensation targets of some insurance products may partially overlap. Therefore, the determination unit 18 may determine a combination of insurance products and insurance premiums further based on the correlation coefficient ρᵢⱼ. The correlation coefficient ρᵢⱼ is a value indicating the degree of correlation between two insurance products (the i-th insurance product and the j-th insurance product) among the n insurance products. The correlation coefficient ρᵢⱼ is a numerical value within a range of 0 to 1. A larger correlation coefficient ρᵢⱼ indicates a stronger correlation between the i-th insurance product and the j-th insurance product. The correlation coefficient ρᵢⱼ is calculated and set in advance for each of two insurance products among the n insurance products. The correlation coefficient ρᵢⱼ is included in the insurance product information, for example, and is acquired from the insurance product information storage unit 20.

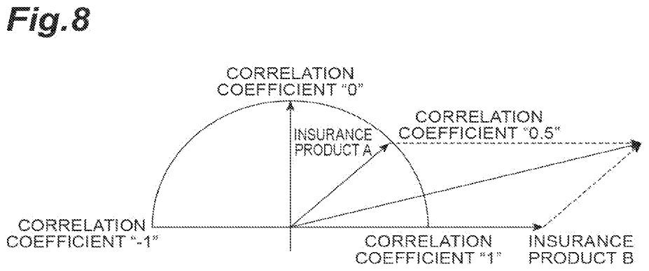

Specifically, the determination unit 18 minimizes Equation (1) so as to further satisfy the constraint condition represented by Equation (5). Equation (5) represents a constraint condition that the sum of the degrees of overlap for all sets of two insurance products selectable from the n insurance products is less than the specified value Sa. The degree of overlap is a value indicating a degree to which compensation targets of two insurance products overlap. As the degree of overlap is larger, the degree to which compensation targets of two insurance products overlap is larger. As shown in the left side of Equation (5), the determination unit 18 calculates the degree of overlap based on the compensation amount and the correlation coefficient ρᵢⱼ for all sets of two insurance products selectable from the n insurance products, and calculates the sum of the degrees of overlap. As shown in FIG. 8, when the correlation coefficient is large, the degree of overlap becomes large. Then, the determination unit 18 determines the portfolio (combination and insurance premium) of the insurance products such that the sum of the degrees of overlap of all sets is less than the specified value Sa.

$$\begin{matrix}[ Equation 5 ] & \\ {\sum }_{i = 1}^{n} {\sum }_{j = 1}^{n} \sqrt{{C}_{i} \times {x}_{i}^{2} + {C}_{j} \times {x}_{j}^{2} + 2 \times {ρ}_{ij} \times {C}_{i} \times {x}_{i} \times {C}_{j} \times {x}_{j}} < Sa & ( 5 )\end{matrix}$$

When several insurance products having strong correlations with each other are selected as a combination of the insurance products included in the portfolio, the range of events that can be compensated by the insurance products may be narrowed. In other words, risk concentration may occur. On the other hand, when several insurance products having weak correlations with each other are selected as a combination of the insurance products included in the portfolio, the range of events that can be compensated by the insurance products can be widened, and the risk can be distributed. Therefore, it can be said that the less the sum of the degrees of overlap for all sets of two insurance products selectable from the n insurance products is, the wider the range of compensation targets is. Therefore, by determining the combination of the insurance products and the insurance premiums such that the sum of the degrees of overlap is less than the specified value Sa, it is possible to further optimize the combination of the insurance products and the insurance premiums.

The risk degree is not limited to the predicted damage amount. The compensation degree is not limited to the compensation amount. For example, the risk score rᵢ may be used as the risk degree. In this case, the compensation score Cᵢ(xᵢ) is used as the compensation degree. The compensation score Cᵢ(xᵢ) is a value indicating a possibility (probability) that the total amount of predicted damage caused by an event which is a compensation target of the insurance product can be compensated by the compensation amount paid depending on the insurance premium. The compensation score Cᵢ(xᵢ) is set in advance for each insurance product. The compensation score Cᵢ(xᵢ) is included in the insurance product information, for example, and is acquired from the insurance product information storage unit 20.

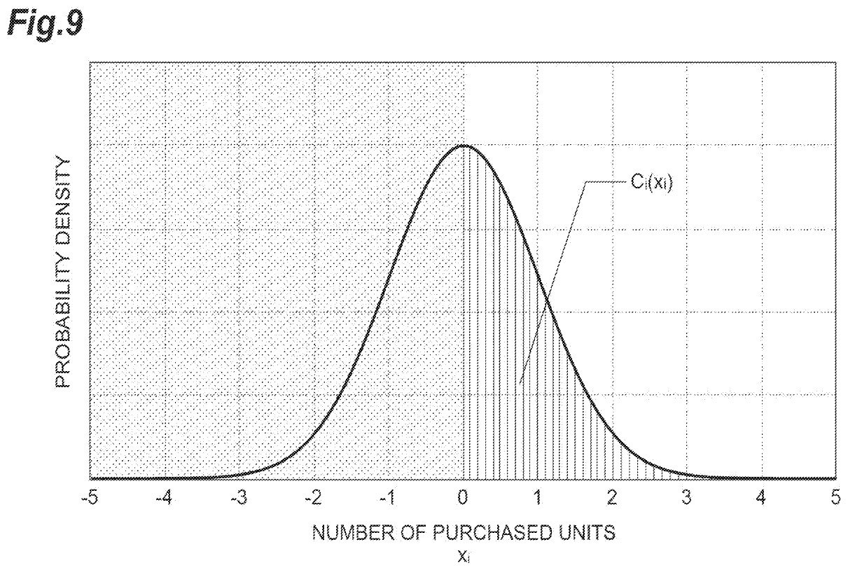

In the example shown in FIG. 9, the compensation score Cᵢ (xᵢ) is represented by the area of the probability density function. Since the compensation amount becomes higher as the insurance premium becomes higher, the possibility that the damage amount can be fully compensated increases. Therefore, as shown in FIG. 9, the compensation score Cᵢ (xᵢ) increases as the insurance premium increases. On the other hand, the possibility that a damage amount larger than the compensation amount occurs decreases as the compensation amount increases. Therefore, as shown in FIG. 9, the increase amount of the compensation score Cᵢ (xᵢ) per unit insurance premium (the number of purchased units) decreases as the insurance premium increases.

In this case, the determination unit 18 uses Equation (6) instead of Equation (1), and minimizes Equation (6) so as to satisfy the constraint conditions represented by Equations (2) to (4). That is, the determination unit 18 determines the combination of the insurance products and the insurance premiums such that the sum of the remaining risk scores obtained by subtracting the compensation scores Cᵢ (xᵢ) from the risk scores rᵢ for the n insurance products is minimized, as shown in Equation (6). Note that when the compensation score Cᵢ (xᵢ) is larger than the risk score rᵢ, it means overcompensation, and in this case, the remaining risk score is regarded as 0.

$$\begin{matrix}[ Equation 6 ] & \\ min {\sum }_{i = 1}^{n} max \{ {r}_{i} \times {C}_{i} ( {x}_{i} ) , 0 \} & ( 6 )\end{matrix}$$

Furthermore, the determination unit 18 may determine a combination of insurance products and insurance premiums further based on the correlation coefficient ρᵢⱼ. Specifically, the determination unit 18 minimizes Equation (1) so as to further satisfy the constraint condition represented by Equation (7) instead of Equation (5). Equation (7) represents a constraint condition that the sum of the degrees of overlap for all sets of two insurance products selectable from the n insurance products is less than the specified value Sb. As shown in the left side of Equation (7), the determination unit 18 calculates the degree of overlap based on the compensation score and the correlation coefficient ρᵢⱼ for all sets of two insurance products selectable from the n insurance products, and calculates the sum of the degrees of overlap. Then, the determination unit 18 determines the portfolio (combination and insurance premium) of the insurance products such that the sum of the degrees of overlap of all sets is less than the specified value Sb.

$$\begin{matrix}[ Equation 7 ] & \\ {\sum }_{i = 1}^{n} {\sum }_{j = 1}^{n} \sqrt{{{C}_{i} ( {x}_{i} )}^{2} + {{C}_{j} ( {x}_{j} )}^{2} + 2 \times {ρ}_{ij} \times {C}_{i} ( {x}_{i} ) \times {C}_{j} ( {x}_{j} )} < Sb & ( 7 )\end{matrix}$$

In this modified example, based on the risk score rᵢ and the compensation score Cᵢ (xᵢ) of each of the n insurance products, a combination of the insurance products and insurance premiums to be paid for the insurance products are determined from among the n insurance products, and recommendation information is output. Since not only the risk score rᵢ but also the compensation score Cᵢ (xᵢ) is considered, for example, it is possible to determine the combination of the insurance products and the insurance premiums so as to be compensated in a balanced manner with respect to various risks of the user. As a result, it is possible to optimize the combination of insurance products and the insurance premiums.

Note that the block diagrams used in the description of the above embodiments show blocks of functional units. These functional blocks (components) are realized by any combination of at least one of hardware and software. The method for realizing each functional block is not particularly limited. That is, each functional block may be realized using a single device coupled physically or logically. Alternatively, each functional block may be realized using two or more physically or logically separated devices that are directly or indirectly (e.g., by using wired, wireless, etc.) connected to each other. The functional blocks may be realized by combining the one device or the plurality of devices mentioned above with software.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating, mapping, assigning, and the like. However, the functions are not limited thereto. For example, a functional block (component) for performing transmission is referred to as a transmitting unit or a transmitter. As explained above, the method for realizing any of the above is not particularly limited.

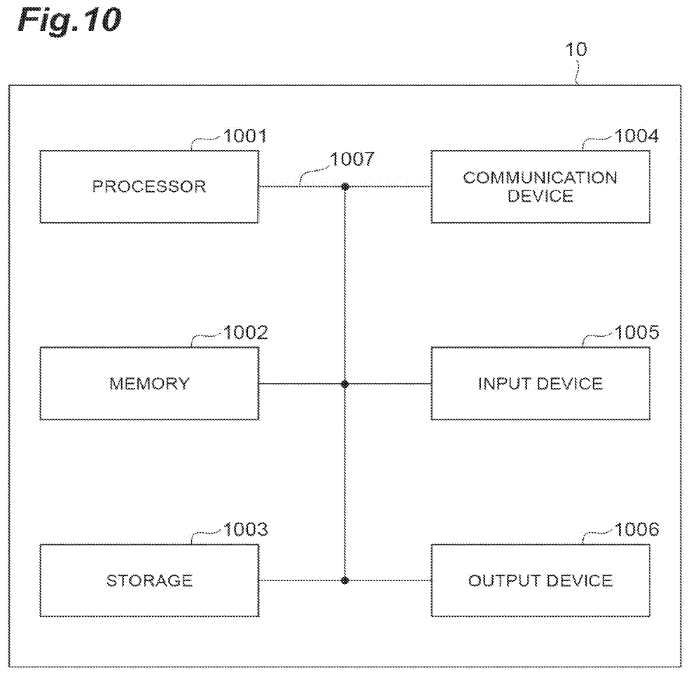

For example, the recommendation device 10 according to one embodiment of the present disclosure may function as a computer performing the processes of the present disclosure. FIG. 10 is a diagram showing an example of the hardware configuration of the recommendation device 10 according to one embodiment of the present disclosure. The above-described recommendation device 10 may be physically configured as a computer device including a processor 1001, a memory 1002, a storage 1003, a communication device 1004, an input device 1005, an output device 1006, a bus 1007, and the like.

In the following description, the term “device” can be read as a circuit, a device, a unit, etc. The hardware configuration of the recommendation device 10 may be configured to include one or more of each device shown in the figure, or may be configured not to include some of the devices.

Each function of the recommendation device 10 is realized by causing the processor 1001, by loading predetermined software (program) onto hardware such as the processor 1001 and the memory 1002, to perform computation to control the communication via the communication device 1004 and to control at least one of reading data from and writing data to the memory 1002 and the storage 1003.

The processor 1001 operates, for example, an operating system to control the entire computer. The processor 1001 may be configured by a central processing unit (CPU) including an interface with a peripheral device, a controller, an arithmetic unit, a register, and the like. For example, each function of the above-described recommendation device 10 may be realized by the processor 1001.

The processor 1001 reads a program (program code), a software module, data, and the like from at least one of the storage 1003 and the communication device 1004 into the memory 1002, and executes various processes in accordance with these. As the program, a program for causing a computer to execute at least a part of the operations described in the above-described embodiments is used. For example, each function of the recommendation device 10 may be realized by a control program stored in the memory 1002 and operating in the processor 1001. Although it has been described that the various processes described above are executed by a single processor 1001, the various processes may be executed simultaneously or sequentially by two or more processors 1001. The processor 1001 may be implemented by one or more chips. The program may be transmitted from a network via a telecommunication line.

The memory 1002 is a computer-readable recording medium, and, for example, may be configured by at least one of a read only memory (ROM), an erasable programmable ROM (EPROM), an electrically erasable programmable ROM (EEPROM), a random access memory (RAM) and the like. The memory 1002 may be referred to as a register, a cache, a main memory (main storage) or the like. The memory 1002 can store executable programs (program codes), software modules, and the like for performing the recommendation method according to one embodiment of the present disclosure.

The storage 1003 is a computer-readable recording medium, and, for example, may be configured by at least one of an optical disc such as a compact disc ROM (CD-ROM), a hard disk drive, a flexible disk, a magneto-optical disc (e.g., a compact disc, a digital versatile disc, a Blu-ray (Registered Trademark) disc), a smart card, a flash memory (e.g., a card, a stick, a key drive), a floppy (Registered Trademark) disk, a magnetic strip, and the like. The storage 1003 may be referred to as an auxiliary storage. The recording medium described above may be, for example, a database, a server, or any other suitable medium that includes at least one of the memory 1002 and the storage 1003.

The communication device 1004 is hardware (transmission/reception device) for performing communication between computers through at least one of a wired network and a wireless network, and is also referred to as a network device, a network controller, a network card, a communication module, or the like. The communication device 1004 may include, for example, a high-frequency switch, a duplexer, a filter, a frequency synthesizer, and the like to realize at least one of frequency division duplex (FDD) and time division duplex (TDD). For example, the acquisition unit 11, the reception unit 17, the output unit 19, and the like described above may be realized by the communication device 1004.

The input device 1005 is an input device (e.g., a keyboard, a mouse, a microphone, a switch, a button, a sensor, or the like) that accepts input from the outside. The output device 1006 is an output device (e.g., a display, a speaker, an LED lamp, etc.) that performs an output to the outside. The input device 1005 and the output device 1006 may be integrated (e.g., a touch panel).

Devices such as the processor 1001 and the memory 1002 are connected to each other with the bus 1007 for communicating information. The bus 1007 may be configured using a single bus or using a separate bus for every two devices.

The recommendation device 10 may include hardware such as a microprocessor, a digital signal processor (DSP), an application specific integrated circuit (ASIC), a programmable logic device (PLD), and a field programmable gate array (FPGA). Some or all of each functional block may be realized by the hardware. For example, the processor 1001 may be implemented using at least one of such hardware components.

Notification of information is not limited to the aspects/embodiments described in the present disclosure, and may be performed using other methods.

In the processing procedures, sequences, flowcharts, and the like of each of the aspects/embodiments described in the present disclosure, the order of processing may be interchanged, as long as there is no inconsistency. For example, the methods described in the present disclosure present the various steps using exemplary order and are not limited to the particular order presented.

Information and the like may be output from an upper layer to a lower layer or may be output from a lower layer to an upper layer. Information and the like may be input and output via a plurality of network nodes.

The input/output information and the like may be stored in a specific location (e.g., a memory) or may be managed using a management table. The information to be input/output and the like can be overwritten, updated, or added. The output information and the like may be deleted. The input information and the like may be transmitted to another device.

The determination may be performed by a value (0 or 1) represented by one bit, a truth value (Boolean: true or false), or a comparison of a numerical value (for example, a comparison with a predetermined value).

The aspects/embodiments described in the present disclosure may be used separately, in combination, or switched with the execution of each aspect/embodiment. The notification of the predetermined information (for example, notification of “being X”) is not limited to being performed explicitly, and may be performed implicitly (for example, without notifying the predetermined information).

Although the present disclosure has been described in detail above, it is apparent to those skilled in the art that the present disclosure is not limited to the embodiments described in the present disclosure.

The present disclosure may be implemented as modifications and variations without departing from the spirit and scope of the present disclosure as defined by the claims. Accordingly, the description of the present disclosure is for the purpose of illustration and has no restrictive meaning relative to the present disclosure.

Software, whether referred to as software, firmware, middleware, microcode, hardware description language, or other names, should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, etc.

Software, an instruction, information, and the like may be transmitted and received via a transmission medium. For example, if software is transmitted from a website, a server, or any other remote source using at least one of wired technologies (such as a coaxial cable, an optical fiber cable, a twisted pair, and a digital subscriber line (DSL)) and wireless technologies (such as infrared light and microwaves), at least one of these wired and wireless technologies is included within the definition of a transmission medium.

The information, signals, and the like described in the present disclosure may be represented using any of a variety of different technologies. For example, data, instructions, commands, information, signals, bits, symbols, chips, etc., which may be referred to throughout the above description, may be represented by voltages, electric currents, electromagnetic waves, magnetic fields or particles, optical fields or photons, or any combination thereof.

It should be noted that terms described in the present disclosure and terms necessary for understanding the present disclosure may be replaced with terms having the same or similar meanings.

The terms “system” and “network” as used in the present disclosure are used interchangeably.

The information, parameters, and the like described in the present disclosure may be expressed using absolute values, relative values from a predetermined value, or other corresponding information.

The names used for the parameters described above are in no way restrictive. Further, the mathematical expressions and the like using these parameters may be different from those explicitly disclosed in the present disclosure.

The term “determining” as used in the present disclosure may encompass a wide variety of operations. The “determining” may include, for example, judging, calculating, computing, processing, deriving, investigating, looking up, search, inquiry (e.g., searching in a table, a database, or another data structure), and ascertaining. The “determining” may include receiving (e.g., receiving information), transmitting (e.g., transmitting information), input, output, and accessing (e.g., accessing data in a memory). The “determining” may include resolving, selecting, choosing, establishing, and comparing. That is, the “determining” may include some operations that may be considered as the “determining”. The “determining” may include some operations that may be considered as the “determining”. The “determining” may be read as “assuming”, “expecting”, “considering”, etc.

The term “connected”, “coupled”, or any variation thereof means any direct or indirect connection or coupling between two or more elements. One or more intermediate elements may be present between two elements that are “connected” or “coupled” to each other. The coupling or connection between the elements may be physical, logical, or a combination thereof. For example, “connection” may be read as “access”. When “connect” or “coupling” is used in the present disclosure, the two elements may be considered to be “connected” or “coupled” to each other using one or more electrical wires, cables, printed electrical connections, and the two elements may be considered to be “connected” or “coupled” to each other using, as some non-limiting and non-exhaustive examples, electromagnetic energy having wavelengths in the radio frequency region, the microwave region, and light (both visible and invisible) regions.

The term “based on” as used in the present disclosure does not mean “based only on” unless otherwise specified. In other words, the term “based on” means both “based only on” and “based at least on”.

Any reference to an element using the designations “first”, “second”, etc., as used in the present disclosure does not generally limit the amount or order of the element. Such designations may be used in the present disclosure as a convenient way to distinguish between two or more elements. Thus, references to the first and second elements do not imply that only two elements may be adopted, or that the first element must precede the second element in any way.

The “unit” in the configuration of each of the above devices may be replaced with “circuit”, “device”, etc.

When “include”, “including”, and variations thereof are used in the present disclosure, these terms are intended to be inclusive, as well as the term “comprising”. Furthermore, the term “or” as used in the present disclosure is intended not to be an exclusive OR.

In the present disclosure, where article such as “a”, “an” and “the” in English is added by translation, the present disclosure may include that the noun following the article is plural.

In the present disclosure, the term “A and B are different” may mean that “A and B are different from each other”. The term may mean that “each of A and B is different from C”. Terms such as “separated” and “combined” may also be interpreted in a similar manner to “different”.

### REFERENCE SIGNS LIST

1—recommendation system, 2—terminal device, 3—user information DB, 4—insurance subscription information DB, 10—recommendation device, 11—acquisition unit, 12—generation unit, 13—calculation unit, 14—risk score storage unit, 15—calculation unit, 16—damage amount storage unit, 17—reception unit, 18—determination unit, 19—output unit, 20—insurance product information storage unit, 1001—processor, 1002—memory, 1003—storage, 1004—communication device, 1005—input device, 1006—output device, 1007—bus.

1. A recommendation device comprising:
a determination unit configured to determine a combination of insurance products and insurance premiums to be paid to the insurance products from among a plurality of insurance products based on a risk degree indicating a degree of damage caused to a user due to an event to be compensated for by each of the plurality of insurance products and a compensation degree indicating a degree of compensation by each of the plurality of insurance products; and
an output unit configured to output recommendation information indicating the combination and the insurance premiums.

2. The recommendation device according to claim 1,
wherein the determination unit determines the combination and the insurance premiums within a range of a payable amount set by the user.

3. The recommendation device according to claim 1,
wherein the determination unit determines the combination and the insurance premiums such that a sum of remaining risk degrees obtained by subtracting the compensation degrees from the risk degrees for the plurality of insurance products is minimized.

4. The recommendation device according to claim 1,
wherein the risk degree is a predicted damage amount caused due to an event to be compensated for by an insurance product, and
wherein the compensation degree is a compensation amount to be paid depending on the insurance premium.

5. The recommendation device according to claim 4,
wherein the determination unit calculates the predicted damage amount based on an occurrence probability of an event to be compensated for by an insurance product.

6. The recommendation device according to claim 1,
wherein the risk degree is an occurrence probability of an event to be compensated for by an insurance product, and
wherein the compensation degree is a probability that a compensation amount to be paid depending on the insurance premium can compensate for a total amount of predicted damage caused due to the event.

7. The recommendation device according to claim 5, further comprising:
a calculation unit configured to calculate a subscription score indicating a possibility that the user subscribes to an insurance product for each of the plurality of insurance products based on user information related to the user, and calculate the occurrence probability for each of the plurality of insurance products based on the subscription score.

8. The recommendation device according to claim 1,
wherein the determination unit determines the combination and the insurance premiums further based on a correlation coefficient indicating a degree of correlation between two insurance products among the plurality of insurance products.

9. The recommendation device according to claim 8,
wherein the determination unit calculates a degree of overlap indicating a degree to which compensation targets of two insurance products overlap for all sets of two insurance products selectable from the plurality of insurance products based on the compensation degree and the correlation coefficient, and determines the combination and the insurance premiums such that a sum of degrees of overlap of all the sets is less than a specified value.

10. The recommendation device according to claim 2,
wherein the determination unit determines the combination and the insurance premiums such that a sum of remaining risk degrees obtained by subtracting the compensation degrees from the risk degrees for the plurality of insurance products is minimized.

11. The recommendation device according to claim 6, further comprising:
a calculation unit configured to calculate a subscription score indicating a possibility that the user subscribes to an insurance product for each of the plurality of insurance products based on user information related to the user, and calculate the occurrence probability for each of the plurality of insurance products based on the subscription score.
